(19) United States
(12) Patent Application Publication
(10) Pub. No.: US 2016/0185258 A1
(43) Pub. Date: Jun. 30, 2016

(54) Pelzer Lift

(71) Applicant: Antoinette Patricia Carr, Glen Burnie, MD (US)

(72) Inventor: Antoinette Patricia Carr, Glen Burnie, MD (US)

(21) Appl. No.: 14/458,155

(22) Filed: Dec. 24, 2014

(51) Int. Cl. B60N 2/02; B60N 2/16; B60N 2/14; B60J 5/04; B60N 2/12

(52) U.S. Cl. CPC B60N 2/0224; B60J 5/0473; B60N 2/12; B60N 2/14; B60N 2/1665

(57) ABSTRACT

The Pelzer Lift provides accessibility to a vehicle for handicapped people and others. It may comprise a vehicle seat, mounted on a telescopic trolley-like system with a hydraulic lift. The vehicle itself can include gull-wing doors for easy entry and exit. When the doors are open, the vehicle seat can move in and out of the vehicle along the extended trolley system. Once outside the vehicle, users can engage the hydraulic lift to move the seat up or down. The seat can also turn in a 360-degree rotation if needed. Once seated, users can return the seat to the appropriate height and slide into the vehicle. They can then retract the trolley system and close the vehicle door. Once inside, the seat can be adjusted in any direction for maximum comfort. The seat can include a control panel for ease of operation.

The Pelzer Lift is a uniquely designed vehicle seat lift that assists handicapped people or anyone with limited flexibility when entering and exiting a vehicle.

### PURPOSE OF THE INVENTION

Enables handicapped people to get in and out of vehicles with ease.
Includes a trolley-like system on which vehicle seats slide in and out and up and down.
Eliminates the pain and struggle associated with entering and exiting vehicles.
Adjusts in height to accommodate various people.
Works in conjunction with gull-wing doors for maximum convenience.

### PROBLEMS SOLVED BY THE INVENTION

It can be difficult for many people, including handicapped people and those with conditions that limit their flexibility, to climb into and out of conventional vehicles. Unfortunately, this process can cause pain and discomfort and may prevent some people from getting around altogether. There are various styles of handicapped vehicle seating options on the market, but these options do not accommodate everyone.

### DETAILED DESCRIPTION

The Pelzer Lift provides accessibility to a vehicle for handicapped people and others. This innovative product may comprise a vehicle seat, mounted on a telescopic trolley-like system with a hydraulic lift. The vehicle itself can include gull-wing doors for easy entry and exit. When the doors are open, the vehicle seat can move in and out of the vehicle along the extended trolley system. Once outside the vehicle, users can engage the hydraulic lift to move the seat up or down to the appropriate height. The seat can also turn in a 360-degree rotation if needed. Once seated, users can return the seat to the appropriate height and slide into the vehicle. They can then retract the trolley system and close the vehicle door. Once inside the vehicle, the seat can be adjusted in any direction for maximum comfort. The seat can include a control panel for ease of operation. The exact specifications may vary upon manufacturing.

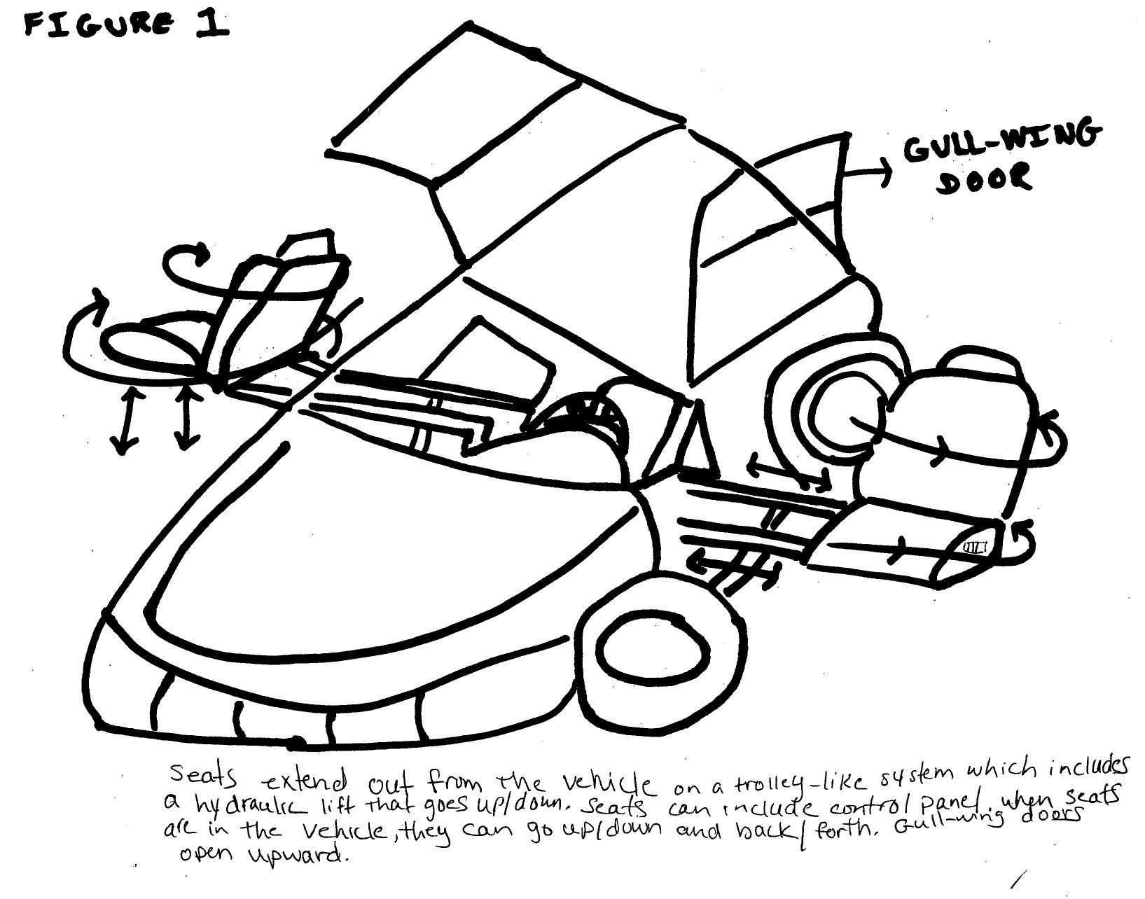

FIG. 1:

The passenger and driver seats can extend out away from the vehicle. The seats are mounted on a telescopic-like system with a hydraulic lift. The vehicle can include gull-wing doors for easy entry/exit. Once outside the vehicle, users can engage the hydraulic lift to move the seat up or down to the appropriate height and slide into the vehicle. The driver can then retract the trolley system and close the door. Once inside the vehicle, the seat can be adjusted in any direction. The seat can include a control panel for ease of operation (SEE ATTACHED).

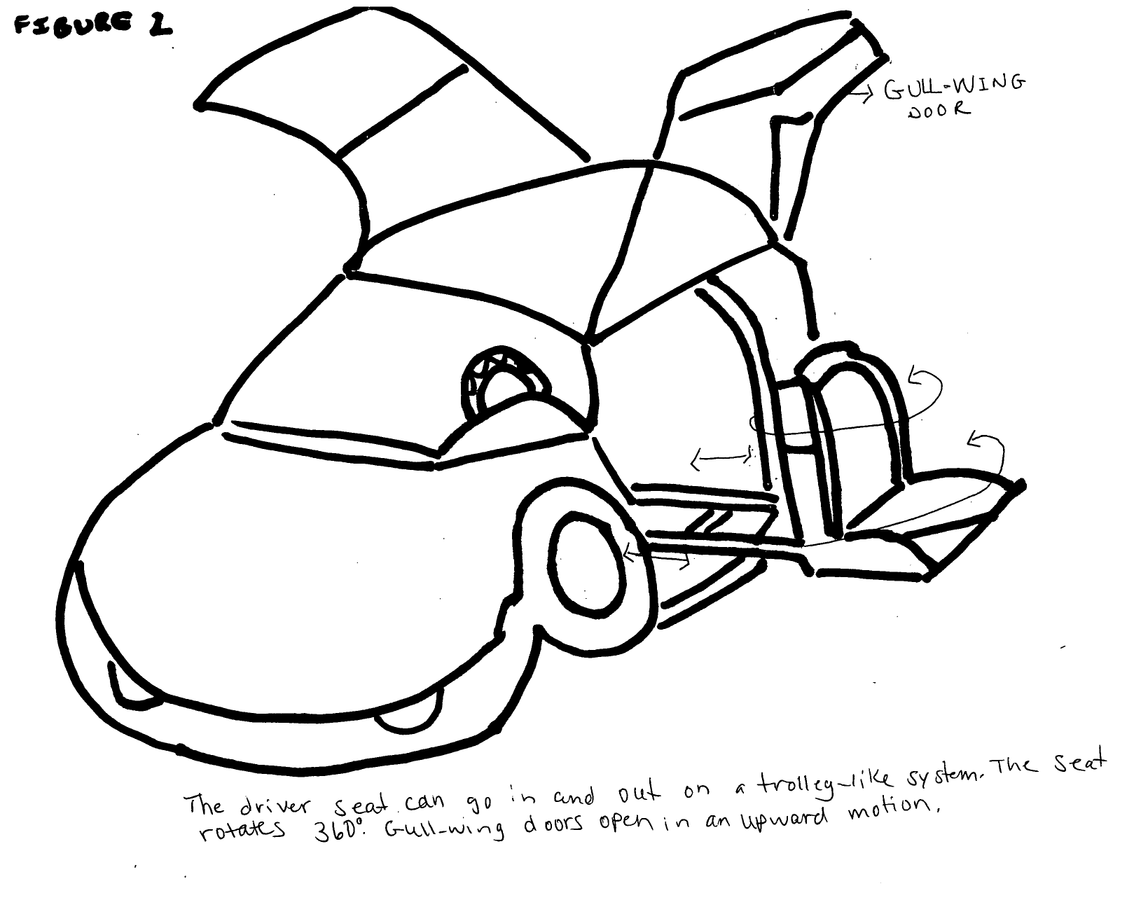

FIG. 2:

This figure shows that the driver seat can go in and then extend out away from the car on a trolley like system. The seats can rotate 360 degrees. The gull-wing doors open in an upward position for easy access (SEE ATTACHED).

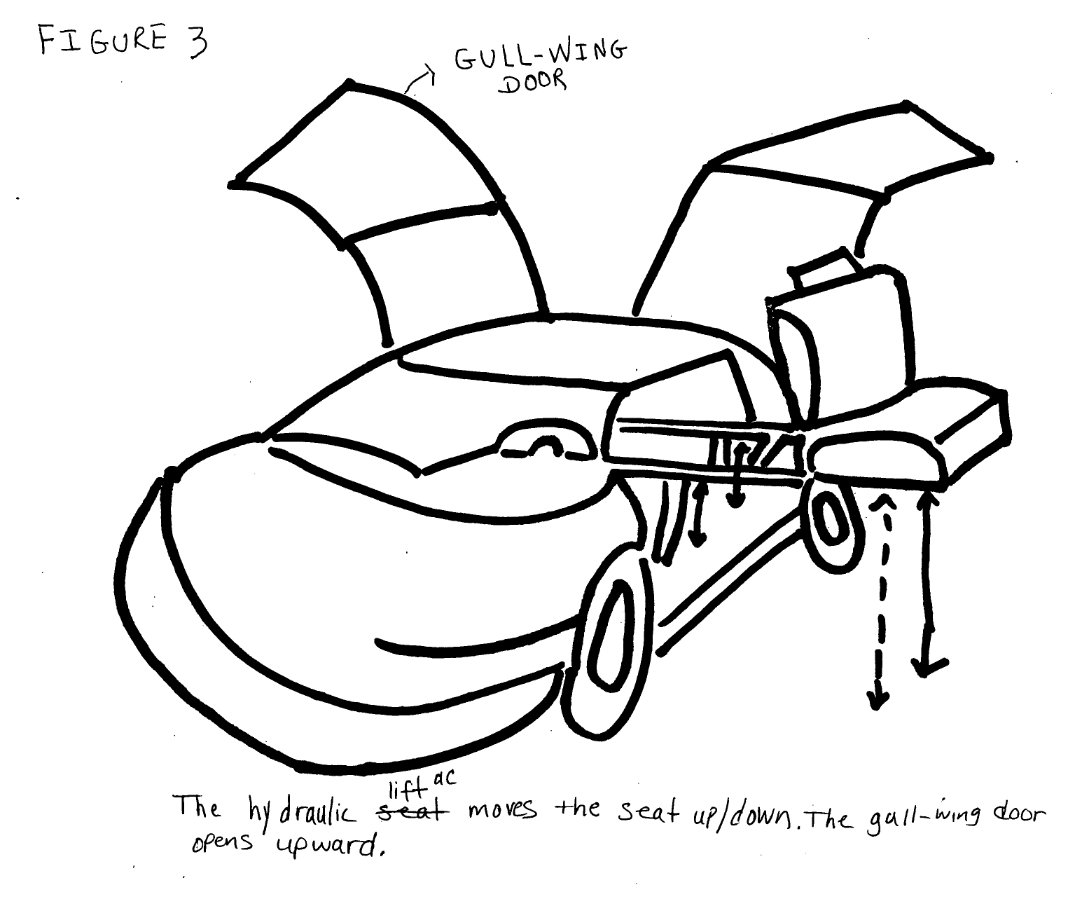

FIG. 3:

This figure shows the hydraulic lift moving the seat up and down to the appropriate height for the driver. The gull-wing doors open up in an upward motion to allow more room and easier access into the vehicle (SEE ATTACHED).

1. The Pelzer Lift is a seat in a vehicle that will be mounted on a telescopic trolley-like system with a hydraulic lift. It has the ability to extend out away from the vehicle. Once the trolley like system is outside of the vehicle, it also has the ability to go up and down as well as rotate 360 degrees. Once inside the vehicle, It can glide forward and backward to extend leg room. To go along with the trolley like system, the doors on the vehicle will be gull-wing doors to further assist with easy entrance into the automobile.
